(19) United States
(12) Patent Application Publication
(10) Pub. No.: US 2018/0155038 A1
(43) Pub. Date: Jun. 7, 2018

(54) Aircraft Parachute System

(71) Applicants: Joseph Miller, Houston, TX (US); Caroline Jackson, Houston, TX (US)

(72) Inventors: Joseph Miller, Houston, TX (US); Caroline Jackson, Houston, TX (US)

(21) Appl. No.: 15/368,108

(22) Filed: Dec. 2, 2016

(51) Int. Cl. B64D 17/80; B64C 25/56

(52) U.S. Cl. CPC B64D 17/80; B64C 25/56

(57) ABSTRACT

An aircraft parachute system includes an aircraft that has a fuselage, a pair of wings, a tail section and a plurality of engines. A plurality of parachute units is provided and each of the parachute units is coupled to the aircraft. Each of the parachute units is selectively deployed when the aircraft experiences an in-flight emergency such that the plurality of parachute units inhibits the aircraft from crashing. A plurality of balloon units is provided and each of the balloon units is coupled to the aircraft. Each of the balloon units is selectively deployed when the aircraft experiences the in-flight emergency. In this way each of the balloon units floats the aircraft in water when the aircraft lands in water.

### BACKGROUND OF THE DISCLOSURE

### Field of the Disclosure

The disclosure relates to parachute devices and more particularly pertains to a new parachute device for inhibiting an aircraft from crashing during an in-flight emergency.

### SUMMARY OF THE DISCLOSURE

An embodiment of the disclosure meets the needs presented above by generally comprising an aircraft that has a fuselage, a pair of wings, a tail section and a plurality of engines. A plurality of parachute units is provided and each of the parachute units is coupled to the aircraft. Each of the parachute units is selectively deployed when the aircraft experiences an in-flight emergency such that the plurality of parachute units inhibits the aircraft from crashing. A plurality of balloon units is provided and each of the balloon units is coupled to the aircraft. Each of the balloon units is selectively deployed when the aircraft experiences the in-flight emergency. In this way each of the balloon units floats the aircraft in water when the aircraft lands in water.

There has thus been outlined, rather broadly, the more important features of the disclosure in order that the detailed description thereof that follows may be better understood, and in order that the present contribution to the art may be better appreciated.

There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a left side view of an aircraft parachute system according to an embodiment of the disclosure showing a plurality of parachute units being deployed.

FIG. 2 is a left side view of an embodiment of the disclosure showing a plurality of balloon units being deployed.

FIG. 3 is a top view of an embodiment of the disclosure.

FIG. 4 is a bottom view of an embodiment of the disclosure.

FIG. 5 is a left side cutaway view of an embodiment of the disclosure.

FIG. 6 is a top perspective view of an embodiment of the disclosure.

FIG. 7 is a schematic view of an embodiment of the disclosure.

### DESCRIPTION OF THE PREFERRED EMBODIMENT

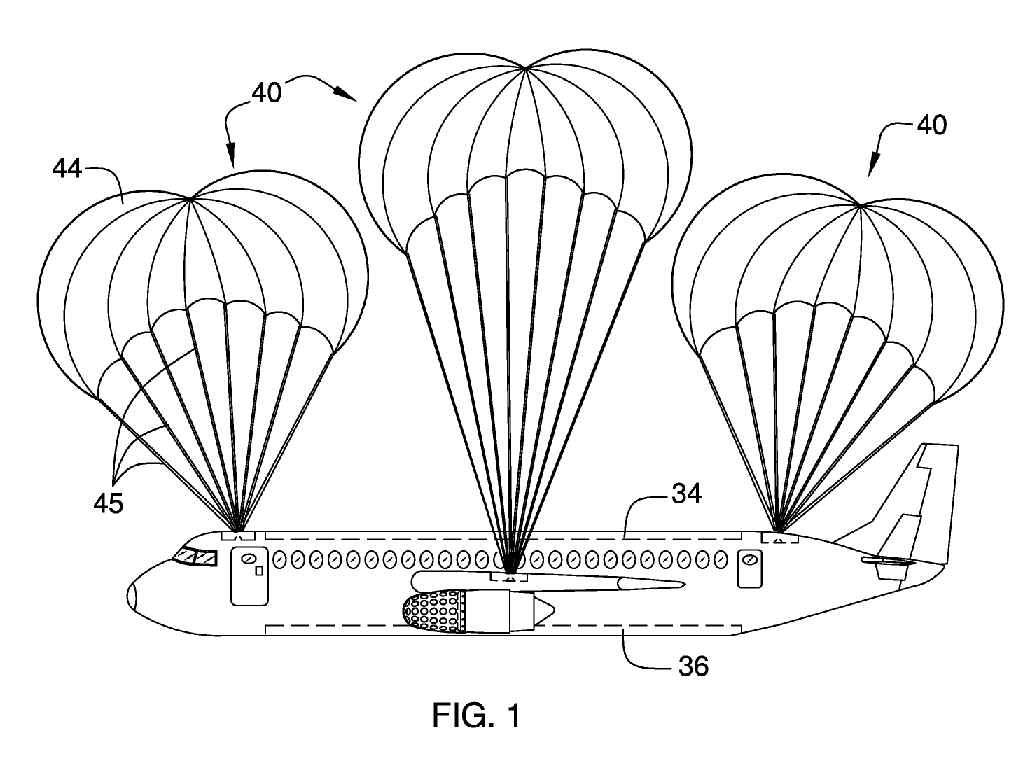

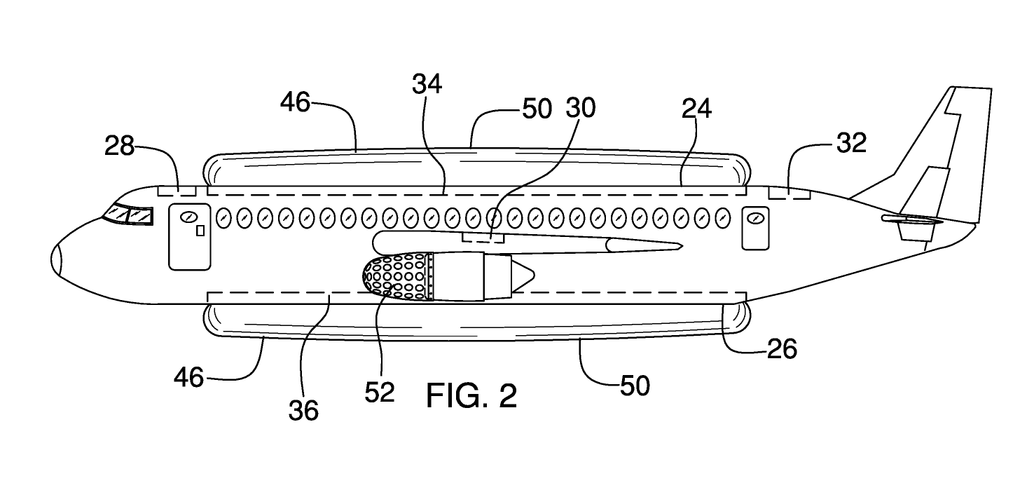

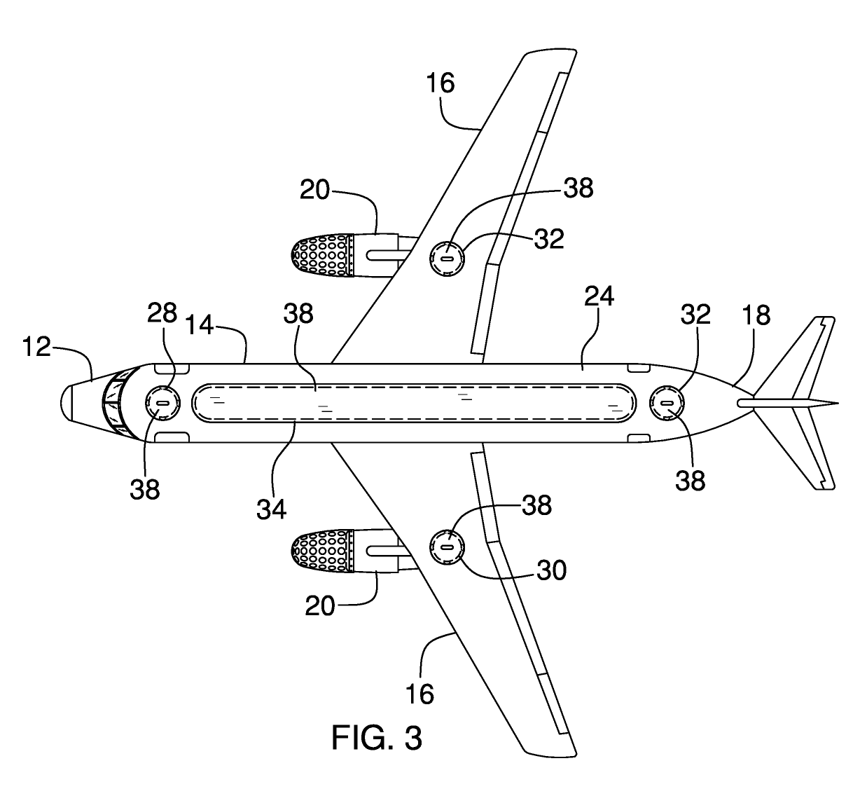

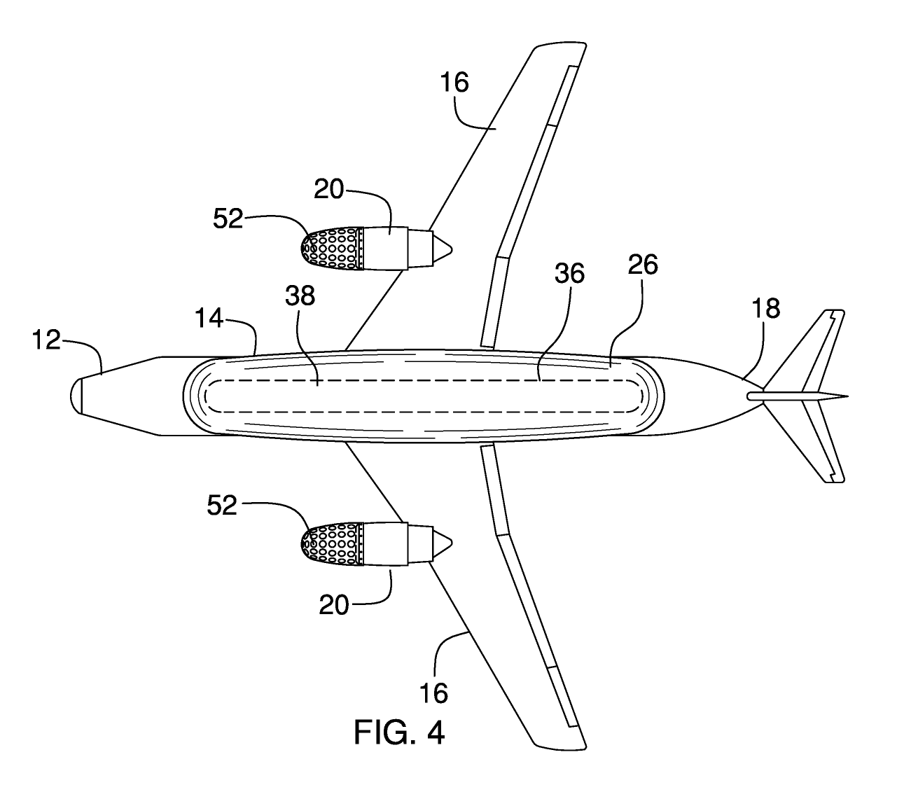

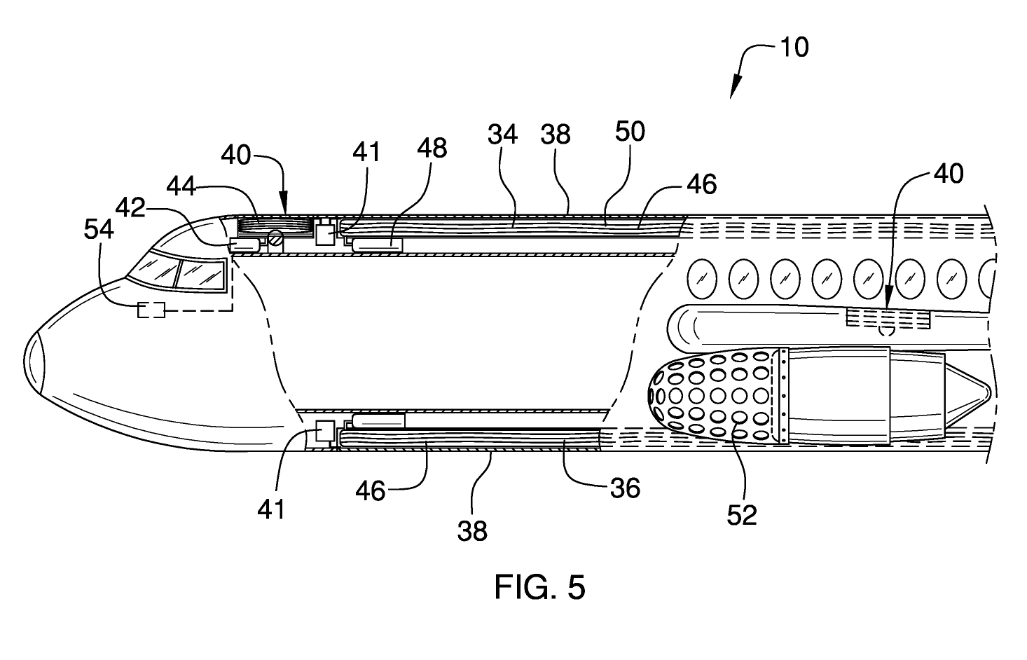

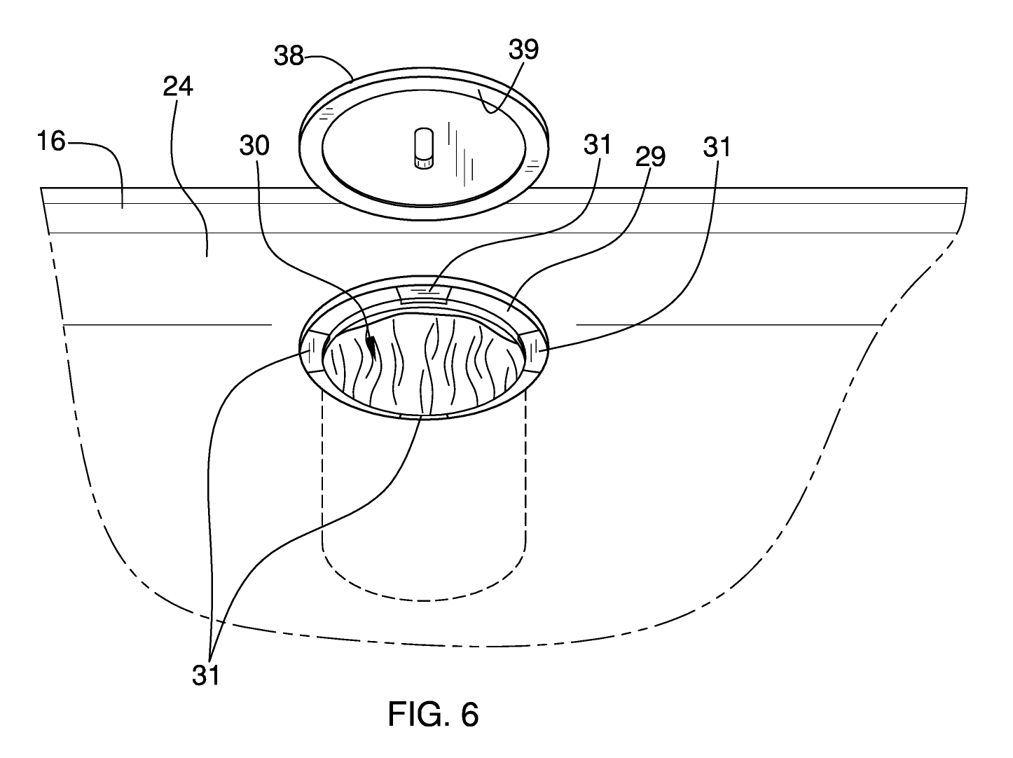

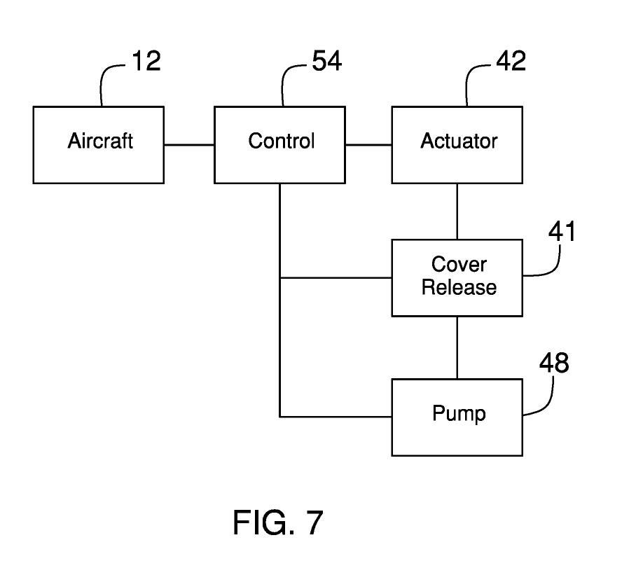

With reference now to the drawings, and in particular to FIGS. 1 through 7 thereof, a new parachute device embodying the principles and concepts of an embodiment of the disclosure and generally designated by the reference numeral 10 will be described.

As best illustrated in FIGS. 1 through 7, the aircraft parachute system 10 generally comprises an aircraft 12 that has a fuselage 14, a pair of wings 16, a tail section 18 and a plurality of engines 20. The aircraft 12 may be a commercial airliner to include, but not being limited to, a Boeing 747, an Airbus A380 or other commercial airliner commonly used to transport a multitude of passengers. Each of the engines 20 may be a jet engine such as a turbo fan engine or the like and each of the engines 20 has an intake 22.

The aircraft 12 has a top side 24 and a bottom side 26. The top side 24 corresponding to the fuselage 14 has a first parachute compartment 28 and the top side 24 corresponding to each of the wings 16 has a second parachute compartment 30. The top side 24 corresponding to the tail section 18 has a third parachute compartment 32. The top side 24 corresponding to the fuselage 14 has a first balloon compartment 34 and the bottom side 26 corresponding to the fuselage 14 has a second balloon compartment 36. Each of the first 28 and second 30 balloon compartments may be substantially collinear with the fuselage 14. The first parachute compartment 28 may be positioned closer to a nose of the aircraft 12 than the tail section 18.

Each of the first 28, second 30 and third 32 parachute compartments has a bounding edge 29. Each of the first 28, second 30 and third 32 parachute compartments further includes a plurality of first mating members 31. The first mating members 31 are coupled to and are distributed around the bounding edge 29 and each of the first mating members 31 may comprise a magnet.

A plurality of covers 38 is provided and each of the covers 38 is removably coupled to the aircraft 12. Each of the covers 38 is positioned to cover an associated one of the first 28, second 30 and third 32 parachute compartments and the first 34 and second 36 balloon 50 compartments. Each of the covers 38 includes a second mating member 39 that is coupled to a bottom surface of the associated cover 38. The second mating member 39 engages each of the first mating members 31 corresponding to the associated first 28, second 30 and third 32 parachute compartments. In this way each of the covers 38 is removably retained on the aircraft 12. The second mating member 39 may be comprised of a magnetic material to magnetically engage the associated first mating members 31.

A plurality of parachute units 40 is provided and each of the parachute units 40 is coupled to the aircraft 12. Each of the parachute units 40 is selectively deployed when the aircraft 12 experiences an in-flight emergency such that the plurality of parachute units 40 inhibits the aircraft 12 from crashing. Each of the parachute units 40 is positioned within an associated one of the first parachute compartment 28, the second parachute 44 compartments and the third parachute 44 compartment. Each of the parachute units 40 comprises an actuator 42 that is positioned within the aircraft 12. The actuator 42 is electrically coupled to the aircraft 12 such that the actuator 42 is selectively turned on to deploy the parachute unit 40 corresponding to the actuator 42.

Each of the parachute units 40 further includes a parachute 44 that is positioned within the aircraft 12. The parachute 44 is urged outwardly from the aircraft 12 when the actuator 42 is turned on. In this way the parachute 44 captures air thereby inhibiting the aircraft 12 from crashing. Each of the parachute 44 unit includes a plurality of lanyards 45 and each of the lanyards 45 is coupled between the parachute 44 and the aircraft 12. Thus, the parachute 44 corresponding to each of the parachute units 40 is attached to the aircraft 12. The actuator 42 corresponding to each of the parachute units may comprise a compressed carbon dioxide tank or the like. The carbon dioxide tank may be in fluid communication with the parachute 44 corresponding to the associated parachute unit 40. The carbon dioxide tank may explosively force the parachute 44 to deploy when the actuator 42 is turned on.

A plurality of balloon units 46 is provided and each of the balloon units 46 is coupled to the aircraft 12. Each of the balloon units 46 is selectively deployed when the aircraft 12 experiences the in-flight emergency. Moreover, each of the balloon units 46 floats the aircraft 12 in water when the aircraft 12 lands in the water. Each of the balloon units 46 is positioned in an associated one of the first balloon compartment 34 and the second balloon compartment 36.

Each of the parachute units 40 and each of the balloon units 46 include a cover release 41 and the cover release 41 is coupled to the aircraft 12. The cover release 41 is electrically coupled to the aircraft 12 and the cover release 41 is aligned with an associated one of the covers 38. The cover release 41 removes the associated cover 38 from the aircraft 12 when the cover release 41 is turned on. The cover release 41 may comprise a mechanical actuator or any other releasing mechanism.

Each of the balloon units 46 comprises a pump 48 that is positioned within the aircraft 12. The pump 48 is electrically coupled to the aircraft 12 such that the pump 48 is selectively turned on to deploy the balloon unit 46 corresponding to the pump 48. The pump 48 may be an electrically controlled pneumatic pump 48 or the like. The pump 48 may be a compressed carbon dioxide bottle or the like.

Each of the balloon units 46 includes a balloon 50 that is positioned within the aircraft 12. The balloon 50 is in fluid communication with the pump 48 such that the pump 48 inflates the balloon 50 when the pump 48 is turned. In this way the balloon 50 is inflated to extend outwardly from the aircraft 12. The balloon 50 is comprised of a puncture resistant material such as polyvinyl chloride or other similar material.

A plurality of screens 52 is provided and each of the screens 52 is coupled to an associated one of the engines 20. Each of the screens 52 is positioned to cover the intake 22 on the associated engine thereby inhibiting an object from entering the associated engine. Moreover, each of the screens 52 facilitates air to enter the associated engine 20. Each of the screens 52 is comprised of an impact resistant material such as steel or the like.

A control 54 is provided and the control 54 is positioned within a cockpit of the aircraft 12 thereby facilitating the control 54 to be manipulated. The control 54 is electrically coupled to the aircraft 12 and the control 54 is electrically coupled to each of the parachute units 40 and each of the balloon units 46. The control 54 selectively turns on the actuator 42, the cover release 41 and the pump 48 corresponding to each of the parachute units 40 and each of the balloon units 46.

In use, each of the parachute units 40 is actuated to deploy when the aircraft 12 experiences an in-flight emergency such as an engine failure or other emergency that exposes the aircraft 12 to a high likelihood of crashing. The parachute 44 corresponding to each of the parachute units 40 deploys and captures air to slowly lower the aircraft 12 to the ground. Each of the balloon units 46 is actuated to deploy when the aircraft 12 is forced to land in water. In this way the aircraft 12 is equipped to float when the aircraft 12 is forced to land in water.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An aircraft parachute system comprising:
an aircraft having a fuselage, a pair of wings, a tail section and a plurality of engines;
a plurality of parachute units, each of said parachute units being coupled to said aircraft, each of said parachute units being selectively deployed when said aircraft experiences an in-flight emergency such that said plurality of parachute units inhibits said aircraft from crashing;
a plurality of balloon units, each of said balloon units being coupled to said aircraft, each of said balloon units being selectively deployed when said aircraft experiences the in-flight emergency wherein each of said balloon units is configured to float the aircraft in water when said aircraft lands in water.

2. The system according to claim 1, wherein said aircraft has a top side and a bottom side, said top side corresponding to said fuselage having a first parachute compartment, said top side corresponding to each of said wings having a second parachute compartment, said top side corresponding to said tail section having a third parachute compartment, said top side corresponding to said fuselage having a first balloon compartment, said bottom side corresponding to said fuselage having a second balloon compartment, each of said engines having an intake.

3. The system according to claim 2, wherein each of said parachute units is positioned within an associated one of said first parachute compartment, said second parachute compartments and said third parachute compartment.

4. The system according to claim 1, further comprising each of said parachute units comprises a actuator being positioned within said aircraft, said actuator being electrically coupled to said aircraft such that said actuator is selectively turned on to deploy said parachute unit corresponding to said actuator.

5. The system according to claim 4, further comprising a parachute being positioned within said aircraft, said parachute being urged outwardly from said aircraft when said actuator is turned on wherein said parachute is configured to capture air thereby inhibiting said aircraft from crashing.

6. The system according to claim 5, further comprising a plurality of lanyards, each of said lanyards being coupled between said parachute and said aircraft.

7. The system according to claim 2, wherein each of said balloon units is positioned in an associated one of said first balloon compartment and said second balloon compartment.

8. The system according to claim 1, wherein each of said balloon units comprises a pump being positioned within said aircraft, said pump being electrically coupled to said aircraft such that said pump is selectively turned on to deploy said balloon unit corresponding to said pump.

9. The system according to claim 8, further comprising a balloon being positioned within said aircraft, said balloon being in fluid communication with said pump such that said pump inflates said balloon when said pump is turned on such that said balloon extends outwardly from said aircraft.

10. The system according to claim 2, further comprising a plurality of screens, each of said screens being coupled to an associated one of said engines wherein each of said screens is configured to inhibit an object from entering said associated engine, each of said screens being positioned to cover said intake on said associated engine.

11. An aircraft parachute system comprising:
an aircraft having a fuselage, a pair of wings, a tail section and a plurality of engines, said aircraft having a top side and a bottom side, said top side corresponding to said fuselage having a first parachute compartment, said top side corresponding to each of said wings having a second parachute compartment, said top side corresponding to said tail section having a third parachute compartment, said top side corresponding to said fuselage having a first balloon compartment, said bottom side corresponding to said fuselage having a second balloon compartment, each of said engines having an intake;
a plurality of parachute units, each of said parachute units being coupled to said aircraft, each of said parachute units being selectively deployed when said aircraft experiences an in-flight emergency such that said plurality of parachute units inhibits said aircraft from crashing, each of said parachute units being positioned within an associated one of said first parachute compartment, said second parachute compartments and said third parachute compartment, each of said parachute units comprising:
a actuator being positioned within said aircraft, said actuator being electrically coupled to said aircraft such that said actuator is selectively turned on to deploy said parachute unit corresponding to said actuator,
a parachute being positioned within said aircraft, said parachute being urged outwardly from said aircraft when said actuator is turned on wherein said parachute is configured to capture air thereby inhibiting said aircraft from crashing, and
a plurality of lanyards, each of said lanyards being coupled between said parachute and said aircraft;
a plurality of balloon units, each of said balloon units being coupled to said aircraft, each of said balloon units being selectively deployed when said aircraft experiences the in-flight emergency wherein each of said balloon units is configured to float the aircraft in water when said aircraft lands in water, each of said balloon units being positioned in an associated one of said first balloon compartment and said second balloon compartment, each of said balloon units comprising:
a pump being positioned within said aircraft, said pump being electrically coupled to said aircraft such that said pump is selectively turned on to deploy said balloon unit corresponding to said pump, and
a balloon being positioned within said aircraft, said balloon being in fluid communication with said pump such that said pump inflates said balloon when said pump is turned on such that said balloon extends outwardly from said aircraft; and
a plurality of screens, each of said screens being coupled to an associated one of said engines wherein each of said screens is configured to inhibit an object from entering said associated engine, each of said screens being positioned to cover said intake on said associated engine.
